(19) United States
(12) Patent Application Publication
(10) Pub. No.: US 2020/0346256 A1
(43) Pub. Date: Nov. 5, 2020

(54) SYSTEMS AND METHODS FOR CLEANING PRESSURE POT COVER ASSEMBLY

(71) Applicant: United Technologies Corporation, Farmington, CT (US)

(72) Inventors: George H. Reynolds, JR., Sanford, ME (US); Anthony G. Ruglio, Rocky Hill, CT (US); Christopher Wright, East Lansing, MI (US)

(21) Appl. No.: 16/403,068

(22) Filed: May 3, 2019

(51) Int. Cl. B08B 9/032; B08B 3/02; B08B 3/10; B05B 15/555

(52) U.S. Cl. CPC B08B 9/0321; B08B 3/02; B08B 2209/032; B05B 15/555; B08B 2203/0211; B08B 3/10

(57) ABSTRACT

A cleaning method is provided during which a cover assembly is removed from a pressure pot of a material spray system. The cover assembly is mated with a wash tank, where the cover assembly closes an opening into the wash tank. Cleaning solution is directed into a cavity of the wash tank and against the cover assembly to remove material residue from the cover assembly.

### BACKGROUND OF THE DISCLOSURE

### 1. Technical Field

This disclosure relates generally to a system with a pressure pot and systems and methods for cleaning a cover assembly of the pressure pot.

### 2. Background Information

Material spray systems are used in the art to apply coating materials onto components. Some known spray systems are configured with a pressure pot to facilitate, among other things, the mixing of the coating material. After a component is coated, the pressure pot and its components are cleaned to remove residue coating material from its surfaces. This cleaning process is typically a manual cleaning process and, thus, labor intensive and time consuming. There is a need in the art therefore for methods and systems operable to automate the cleaning process of a pressure pot and, for example, an associated pressure pot cover assembly.

### SUMMARY OF THE DISCLOSURE

According to an aspect of the present disclosure, a cleaning method is provided during which a cover assembly is removed from a pressure pot of a material spray system. The cover assembly is mated with a wash tank, where the cover assembly closes an opening into the wash tank. Cleaning solution is directed into a cavity of the wash tank and against the cover assembly to remove material residue from the cover assembly.

According to another aspect of the present disclosure, a method is provided during which coating material is applied onto a component of a gas turbine engine using a material spray system that includes a pressure pot and a cover assembly for the pressure pot. Subsequent to the applying of the coating, the cover assembly is removed from the pressure pot. The cover assembly is arranged on a wash tank. Residue from the coating material is removed off of the cover assembly using a cleaning solution while the cover assembly is arranged on the wash tank.

According to still another aspect of the present disclosure, a cleaning system is provided for a pressure pot cover assembly of a material spray system, where the pressure pot cover assembly includes a lid and one or more tools projecting from the lid. The cleaning system includes a wash tank and a cleaning assembly. The wash tank has an internal cavity and is configured to receive the one or more tools of the pressure pot cover assembly. An opening into the internal cavity is configured to be closed by the lid of the pressure pot cover assembly. The cleaning assembly is arranged within the internal cavity of the wash tank. The cleaning assembly is configured to direct cleaning solution against the pressure pot cover assembly to remove material residue from the pressure pot cover assembly.

The cleaning system may also include a supply tank and a reclaim tank. The supply tank is fluidly coupled with the cleaning assembly. The supply tank is configured to provide the cleaning solution to the cleaning assembly. The reclaim tank is fluidly coupled with the internal cavity of the wash tank. The reclaim tank is configured to receive the cleaning solution after being directed against the pressure pot cover assembly.

The cleaning assembly may be configured as or otherwise include a nozzle configured to direct the cleaning solution against a tube of a material pickup device. The one or more tools may be or include the material pickup conduit.

The cleaning assembly may be configured as or otherwise include a jet ring configured to circumscribe and direct the cleaning solution against a mixing device. The one or more tools may be or include the mixing device.

The cleaning assembly may be configured as or otherwise include a jet ring configured to direct the cleaning solution against an underside of a lid of the pressure pot cover assembly.

The cover assembly may include a lid and a tool. When the cover assembly is mated with the wash tank: (A) the lid may close the opening into the wash tank; and/or (B) the tool may project into the cavity of the wash tank from the lid.

The tool may be configured as or otherwise include a mixing device.

The tool may be configured as or otherwise include a material pickup device.

When the cover assembly is mated with the pressure pot: (A) the lid may close and seal an opening into the pressure pot; and/or (B) the tool may project into a cavity of the pressure pot and interact with spray material within the cavity of the pressure pot.

The directing of the cleaning solution may include directing the cleaning solution into a cavity of the wash tank and against the cover assembly from a nozzle.

The nozzle may be configured to direct the cleaning solution upwards and against a tube of a material pickup device of the cover assembly.

The directing of the cleaning solution may include directing the cleaning solution into the cavity of the wash tank and against the cover assembly from a jet ring.

The jet ring may be configured to circumscribe and direct the cleaning solution against a mixing device of the cover assembly.

The jet ring may be configured to direct the cleaning solution against an underside of a lid of the cover assembly.

The jet ring may be disposed within the cavity. The jet ring may include a plurality of orifices arranged circumferentially in an annular array.

The method may also include receiving the cleaning solution from a cleaning solution supply tank.

The method may also include directing the cleaning solution that was directed against the cover assembly within the wash tank into a cleaning solution reclaim tank.

The method may also include directing the cleaning solution into a conduit of the cover assembly to remove material residue from within the conduit.

The material residue may be residue material from applying a coating onto a component of a gas turbine engine using the pressure pot.

The foregoing features and the operation of the invention will become more apparent in light of the following description and the accompanying drawings.

### BRIEF DESCRIPTION OF THE DRAWINGS

FIG. 1 is a partial schematic illustration of a material spray system applying coating material onto a component.

FIG. 2 is a partial schematic illustration of a cleaning system.

FIG. 3 is a partial schematic illustration of a pressure pot cover assembly mated with a wash tank of the cleaning system.

FIG. 4 is a flow diagram of a method utilizing a material spray system and a cleaning system.

### DETAILED DESCRIPTION

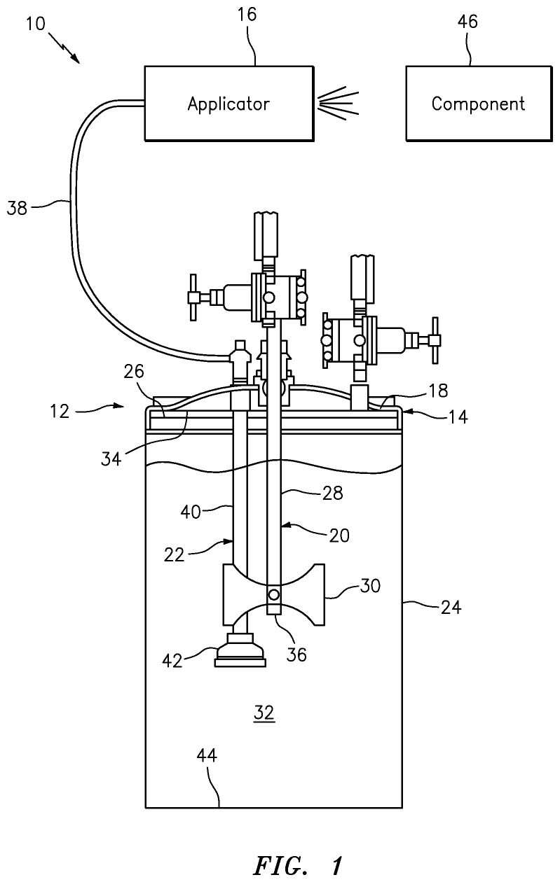

The present disclosure includes systems and methods for cleaning or otherwise involving a material spray system, which may also be referred to as a material application system and/or a coating system. An exemplary material spray system 10 is schematically illustrated in FIG. 1 and briefly described below. The present disclosure, however, is not limited to the exemplary material spray system configuration shown in FIG. 1. Rather, the systems and methods of the present disclosure may be implemented with various different material spray system configurations that utilize a pressure pot cover assembly.

The material spray system 10 of FIG. 1 includes a pressure pot 12 configured with a pressure pot cover assembly 14. The material spray system 10 also includes an applicator 16 such as, but not limited to, a device with one or more nozzles.

The cover assembly 14 includes a lid 18 and one or more tools 20 and 22. The lid 18 is configured to mate with a tank 24 of the pressure pot 12. More particularly, the lid 18 is configured to be placed onto a top end 26 of the pressure pot tank 24 so as to close and seal an opening into the pressure pot tank 24. At least a combination of the lid 18 and the pressure pot tank 24 may thereby collectively form a pressure vessel.

The one or more tools may include a mixing device 20 and a material pickup device 22. The mixing device 20 of FIG. 1 includes a rotatable shaft 28 and a rotatable mixing head 30 such as, but not limited to, a mixing impeller. The shaft 28 projects downward into an internal cavity 32 of the pressure pot tank 24 and the pressure pot 12 from an underside 34 of the lid 18 to a distal shaft end 36. The mixing head 30 is connected to the shaft 28 at (e.g., on, adjacent or proximate) the distal shaft end 36. The mixing head 30 is thereby arranged within the cavity 32 and is operable to mix (e.g., stir) material within the cavity 32 of the pressure pot tank 24. Examples of material which may be contained in the pressure pot internal cavity 32 include, but are not limited to, polyurethanes, adhesives, sealants, conversion, lubricant type coatings.

The material pickup device 22 is configured to provide (e.g., flow and/or direct) the mixed material from within the cavity 32 to the applicator 16. The material pickup device 22 of FIG. 1, for example, is fluidly coupled to the applicator 16 through at least an external conduit 38. The material pickup device 22 of FIG. 1 includes a length of conduit 40 and a pickup tube 42. The conduit 40 projects downward into the cavity 32 from the underside 34 of the lid 18 to a distal conduit end. The pickup tube 42 is connected to the conduit 40 at the distal conduit end. The specific pickup tube 42 of FIG. 1 is configured as either a straight body or a cupped body, where an opening either straight or into a recess formed by the cupped body faces a bottom 44 of the pressure pot tank 24. This pickup tube 42 is located vertically beneath the mixing head 30.

During operation of the material spray system 10, the material within the pressure pot cavity 32 is mixed by the mixing device 20. This mixed material is directed out of the cavity 32 via the material pickup device 22 and provided to the applicator 16 for application (e.g., spraying) onto at least a portion of a surface of a component 46. An example of the component 46 is a component of a gas turbine engine; e.g., air airfoil for a rotor blade (e.g., a fan blade, a compressor blade or a turbine blade) or a stator vane. Of course, various other gas turbine engine components as well as non-gas turbine engine components may alternatively be coated using the material spray system 10. For example, the component 46 may be a platform or a gas path wall (e.g., a liner).

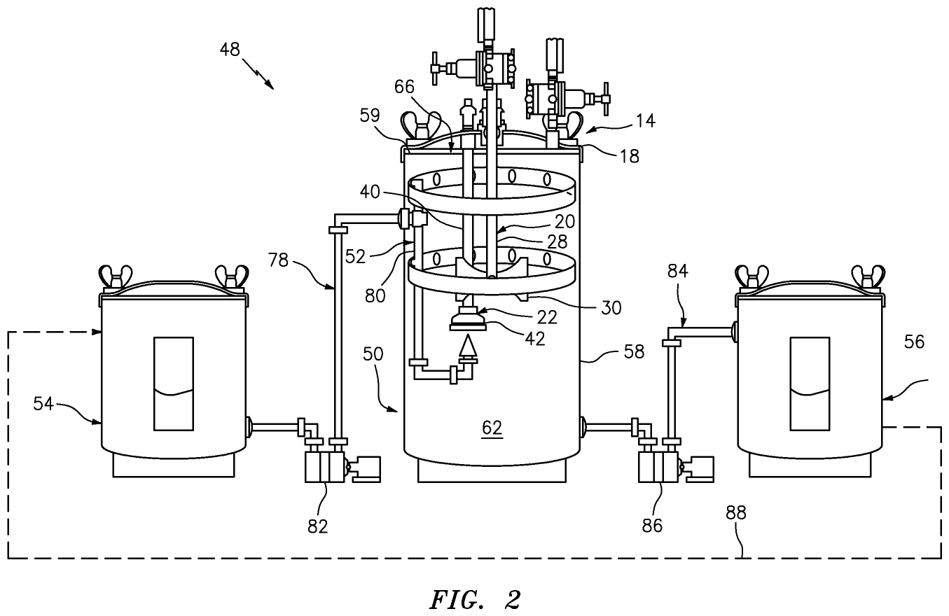

After the coating component process, leftover/remaining coating material is removed from the pressure pot 12. However, wet and/or dried residue of this coating material may still coat various surfaces of the pressure pot 12. These surfaces include, but are not limited to, (a) a surface on the underside 34 of the lid 18, (b) exterior surfaces of the mixing device 20 and its elements 28 and 30, (c) exterior surfaces of the material pickup device 22 and its elements 40 and 42 and (d) internal surfaces of the material pickup device 22 and its elements 40 and 42 (e.g., interior conduit and pickup tube surfaces). To prevent this residue material from contaminating subsequent coating processes and/or reducing efficiency/operability of the material spray system 10, the pressure pot cover assembly 14 may be cleaned utilizing a cleaning system 48 as illustrated, for example, in FIG. 2.

The cleaning system 48 of FIG. 2 is configured to remove (partially or completely) the wet and/or dried residue material from one or more surfaces (e.g., the above described surfaces) of the pressure pot cover assembly 14. This cleaning system 48 includes a wash tank 50 and an associated cleaning assembly 52. The cleaning system 48 of FIG. 2 also includes a supply tank 54 and/or a reclaim tank 56.

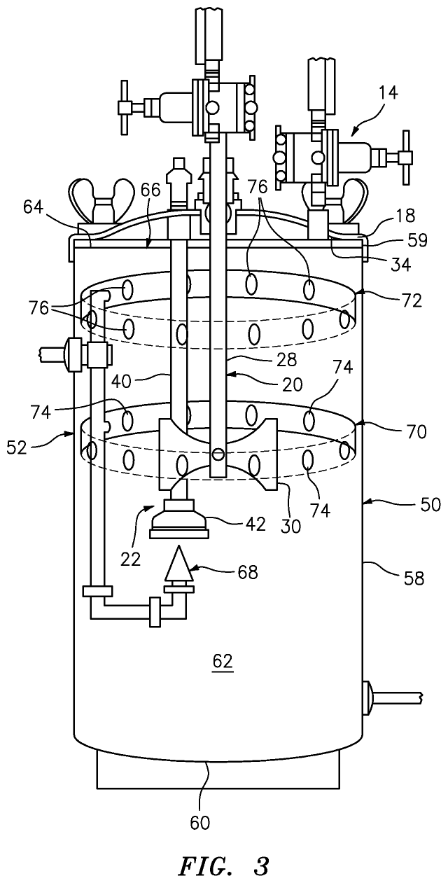

Referring to FIG. 3, the wash tank 50 is configured as an open ended container such as a bucket or basin. The wash tank 50 includes a tubular sidewall 58 and an endwall 60 that form an internal cavity 62. This internal cavity 62 is sized to receive the one or more tools 20 and 22 of the pressure pot cover assembly 14. The wash tank 50 is similarly configured to mate with the lid 18 of the pressure pot cover assembly 14. More particularly, as similarly described above with respect to the pressure pot tank 24, the wash tank 50 is configured such that the lid 18 may be placed onto a top end 64 of the wash tank 50 (e.g., contacting a rim 59 of the tubular sidewall 58) so as to close and seal an opening 66 into the wash tank 50. At least a combination of the lid 18 and the wash tank 50 may thereby collectively form a pressure vessel.

The cleaning assembly 52 is configured to direct cleaning solution into the wash tank cavity 62 and against the pressure pot cover assembly 14 and its surfaces to remove the residue material from the cover assembly 14. The cleaning assembly 52 of FIG. 3, for example, includes a (e.g., standalone) spray nozzle 68 and one or more jet rings 70 and 72 (schematically shown).

The spray nozzle 68 is configured to direct the cleaning solution against the pickup tube 42 of the material pickup device 22. The nozzle 68 may also or alternatively be configured to direct the cleaning solution into the recess of the pickup tube 42 as well as into an internal passage of the conduit 40. The nozzle 68, for example, is disposed within the wash tank 50 and its cavity 62. This nozzle 68 is aligned with the material pickup device 22 and oriented to direct a jet or spray of the cleaning solution upwards towards the material pickup device 22. Of course, in other embodiments, the nozzle 68 may be mated with the pickup tube 42 so as to flow the cleaning solution through the material pickup device 22; e.g., through internal passage of the conduit 40.

The first (e.g., lower) jet ring 70 is disposed within the wash tank 50 and its cavity 62. The first jet ring 70 circumscribes the mixing device 20 and its head 30 as well as the conduit 40. The first jet ring 70 includes one or more orifices 74 (e.g., nozzle orifices) arranged circumferentially in an annular array. Each of these orifices 74 is configured to direct a jet or spray of the cleaning solution radially inwards towards the mixing head 30.

The second (e.g., upper) jet ring 72 is disposed within the wash tank 50 and its cavity 62. The second jet ring 72 circumscribes the shaft 28, mixing head 30 and conduit 40. The second jet ring 72 includes one or more orifices 76 (e.g., nozzle orifices) arranged circumferentially in an annular array. Each of these orifices 76 is configured to direct a jet or spray of the cleaning solution radially inwards towards the tool elements 28, 30 and 40 and/or upwards towards the underside 34 of the lid 18.

Referring to FIG. 2, the supply tank 54 is configured to store the cleaning solution prior to use in the wash tank 50. The supply tank 54 is further configured to provide the stored cleaning solution to the wash tank 50. The supply tank 54 of FIG. 2, for example, is fluidly coupled with the cleaning assembly 52 and its components through a supply line 78 and a manifold 80 of the cleaning assembly 52. At least a portion of the supply line 78 is external to the wash tank 50 and the supply tank 54. The manifold 80 is arranged within the wash tank cavity 62. A pump 82 may be fluidly coupled inline with the supply line 78 to draw the cleaning solution out from the supply tank 54 and pump that solution into the cleaning assembly 52 and, therethrough, the wash tank cavity 62.

The reclaim tank 56 is configured to receive used cleaning solution from the wash tank 50. The term “used cleaning solution” describes cleaning solution that has already been directed against the pressure pot cover assembly 14 by the cleaning assembly 52. The reclaim tank 56 of FIG. 2, for example, is fluidly coupled to a sump area of the wash tank 50 through a reclaim line 84 that is external to the wash tank 50 and the reclaim tank 56. A pump 86 may be fluidly coupled inline with the reclaim line 84 to draw the used cleaning solution out from the wash tank 50 and pump that solution into the reclaim tank 56.

In some embodiments, the reclaim tank 56 may be further fluidly coupled with the supply tank 54 by a return line 88. This return line 88 may enable at least some of the reclaimed cleaning solution to be reused for subsequent cleaning operations. Of course, in other embodiments, the return line 88 may be omitted such that the tanks 54 and 56 are only fluidly coupled through the wash tank 50.

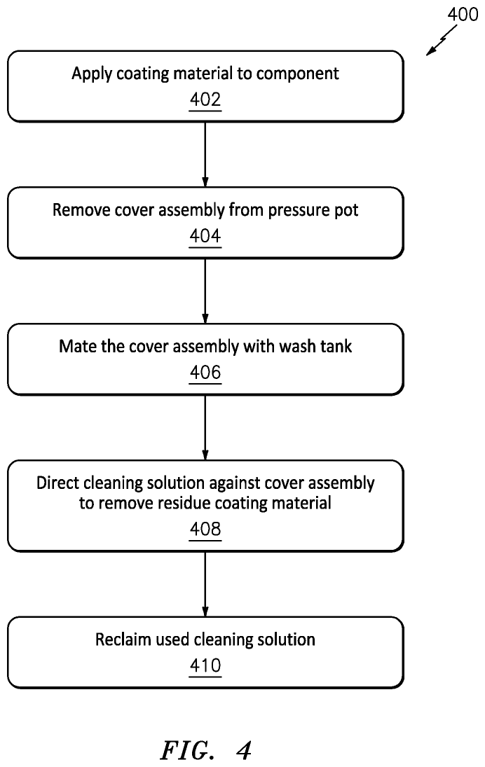

FIG. 4 is a flow diagram of a method 400 for utilizing a cleaning system such as the cleaning system 48 of FIG. 2. This method 400 is also described utilizing a material spray system such as the material spray system 10 of FIG. 1. The method 400, however, may also be implemented with alternative cleaning systems and/or material spray systems.

In step 402, coating material is applied to a component 46. For example, the material spray system 10 may be used to coat one or more surfaces of the component 46 with the coating material.

In step 404 and subsequent to performance of the application (the step 402) of the coating material, the pressure pot cover assembly 14 is removed from the pressure pot 12.

In step 406, the pressure pot cover assembly 14 is mated with the wash tank 50. The tools 20 and 22, for example, are inserted into the wash tank cavity 62. The lid 18 is placed onto the rim 59 of the tubular sidewall 58 so as to cover and seal the opening 66 in the wash tank 50.

In step 408, cleaning solution is directed against the pressure pot cover assembly 14 to remove (completely or partially) wet and/or dried residue coating material. The cleaning assembly 52, for example, directs the cleaning solution into the cavity 62 and against the surfaces of the cover assembly elements 18, 20, 22, 28, 30, 40 and/or 42. The cleaning solution may remove the residue coating material from the pressure pot cover assembly 14 via the force of impact of the cleaning solution onto the residue coating material and/or via chemically dissolving the residue coating material.

In step 410, used cleaning solution is reclaimed. The used cleaning solution, for example, is directed out of the wash tank cavity 62 and into the reclaim tank 56. This reclaimed cleaning solution may then be stored within the reclaim tank 56 until a subsequent cleaning operation. Alternatively, the used cleaning solution may be recirculated to the supply tank 54 to replenish the cleaning solution contained therein; e.g., via return line 88. Of course, the used cleaning solution may first be processed (e.g., filtered, tested, etc.) prior to being provided back to the supply tank 54.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. A cleaning method, comprising:
removing a cover assembly from a pressure pot of a material spray system;
mating the cover assembly with a wash tank, wherein the cover assembly closes an opening into the wash tank; and
directing cleaning solution into a cavity of the wash tank and against the cover assembly to remove material residue from the cover assembly.

2. The cleaning method of claim 1, wherein
the cover assembly includes a lid and a tool; and
when the cover assembly is mated with the wash tank:
the lid closes the opening into the wash tank; and
the tool projects into the cavity of the wash tank from the lid.

3. The cleaning method of claim 2, wherein the tool comprises a mixing device.

4. The cleaning method of claim 2, wherein the tool comprises a material pickup conduit.

5. The cleaning method of claim 2, wherein when the cover assembly is mated with the pressure pot:
the lid closes and seals an opening into the pressure pot; and
the tool projects into a cavity of the pressure pot and interacts with spray material within the cavity of the pressure pot.

6. The cleaning method of claim 1, wherein the directing of the cleaning solution comprises directing the cleaning solution into a cavity of the wash tank and against the cover assembly from a nozzle.

7. The cleaning method of claim 6, wherein the nozzle is configured to direct the cleaning solution upwards and against a tube of a material pickup device of the cover assembly.

8. The cleaning method of claim 1, wherein the directing of the cleaning solution comprises directing the cleaning solution into the cavity of the wash tank and against the cover assembly from a jet ring.

9. The cleaning method of claim 8, wherein the jet ring is configured to circumscribe and direct the cleaning solution against a mixing device of the cover assembly.

10. The cleaning method of claim 8, wherein the jet ring is configured to direct the cleaning solution against an underside of a lid of the cover assembly.

11. The cleaning method of claim 8, wherein the jet ring is disposed within the cavity and comprises a plurality of orifices arranged circumferentially in an annular array.

12. The cleaning method of claim 1, further comprising receiving the cleaning solution from a cleaning solution supply tank.

13. The cleaning method of claim 1, further comprising directing the cleaning solution that was directed against the cover assembly within the wash tank into a cleaning solution reclaim tank.

14. The cleaning method of claim 1, further comprising directing the cleaning solution into a conduit of the cover assembly to remove material residue from within the conduit.

15. The cleaning method of claim 1, wherein the material residue comprises residue material from applying a coating onto a component of a gas turbine engine using the pressure pot.

16. A method, comprising:
applying coating material onto a component of a gas turbine engine using a material spray system that comprises a pressure pot and a cover assembly for the pressure pot;
subsequent to the applying of the coating, removing the cover assembly from the pressure pot;
arranging the cover assembly on a wash tank; and
removing residue from the coating material off of the cover assembly using a cleaning solution while the cover assembly is arranged on the wash tank.

17. A cleaning system for a pressure pot cover assembly of a material spray system, the pressure pot cover assembly comprising a lid and one or more tools projecting from the lid, and the cleaning assembly comprising:
a wash tank with an internal cavity configured to receive the one or more tools of the pressure pot cover assembly, and an opening into the internal cavity configured to be closed by the lid of the pressure pot cover assembly; and
a cleaning assembly arranged within the internal cavity of the wash tank, the cleaning assembly configured to direct cleaning solution against the pressure pot cover assembly to remove material residue from the pressure pot cover assembly.

18. The cleaning system of claim 17, wherein
the cleaning assembly comprises a nozzle configured to direct the cleaning solution against a tube of a material pickup device; and
the one or more tools comprises the material pickup conduit.

19. The cleaning system of claim 17, wherein
the cleaning assembly comprises a jet ring configured to circumscribe and direct the cleaning solution against a mixing device; and
the one or more tools comprises the mixing device.

20. The cleaning system of claim 17, wherein the cleaning assembly comprises a jet ring configured to direct the cleaning solution against an underside of a lid of the pressure pot cover assembly.

21. The cleaning system of claim 17, further comprising:
a supply tank fluidly coupled with the cleaning assembly, the supply tank configured to provide the cleaning solution to the cleaning assembly; and
a reclaim tank fluidly coupled with the internal cavity of the wash tank, the reclaim tank configured to receive the cleaning solution after being directed against the pressure pot cover assembly.
